(19) United States
(12) Patent Application Publication
(10) Pub. No.: US 2017/0103205 A1
(43) Pub. Date: Apr. 13, 2017

(54) MEMORY HACKING DETECTING METHOD AND SYSTEM THEREFOR

(71) Applicant: LINE Corporation, Tokyo (JP)

(72) Inventors: Sungbeom AHN, Seongnam-si (KR); Kwang-Hee HAN, Seongnam-si (KR); Seong Yeol LIM, Seongnam-si (KR); Dongpil SEO, Seongnam-si (KR); Wang Jin OH, Seongnam-si (KR); SangHun JEON, Seongnam-si (KR); Myungju CHUNG, Seongnam-si (KR)

(73) Assignee: LINE Corporation, Tokyo (JP)

(21) Appl. No.: 15/201,832

(22) Filed: Jul. 5, 2016

(30) Foreign Application Priority Data
Oct. 7, 2015 (KR) 10-2015-0141092

(51) Int. Cl. G06F 21/56; G06F 12/14

(52) U.S. Cl. CPC G06F 21/566; G06F 12/1458; G06F 2212/1052; G06F 2221/034

(57) ABSTRACT

A memory hacking detecting method and a system therefor are provided. The memory hacking detecting method for accurately detecting a level of a hacker (or a cheating user) and action of memory hacking by detecting the memory hacking on a stage-by-stage basis and assigning attributes to each of variables of a program executed on a memory and detecting memory hacking in different ways based on the assigned attributes.

### CROSS-REFERENCE TO RELATED APPLICATIONS

A claim for priority under 35 U.S.C. §119 is made to Korean Patent Application No. 10-2015-0141092 filed Oct. 7, 2015, in the Korean Intellectual Property Office, the entire contents of which are hereby incorporated by reference.

### BACKGROUND

Example embodiments of the inventive concepts described herein relate to memory hacking detecting methods and/or systems therefor.

Memory hacking refers to action of forging or falsifying data stored in a memory. For example, in connection with an application installed in an electronic device, a hacker may obtain and forge or falsify a desired variable value by searching a memory for the variable value changed based on specific fabrication on an executed application.

Methods for preventing this memory hacking may be divided into a first method and a second method.

The first method is a method of encrypting a value of a variable and storing the encrypted value of the variable in a memory. For example, the first method may include a simple encryption method of converting a scalar value (a 4-type value) into a string value (a 32-byte value), storing the converted string value in the memory, and decrypting the string value when the value is being used. However, there may be additional costs for encrypting and decrypting data in the first method. Further, recent developments in cheating tools may provide a hacker with a function of searching for an encrypted value, such that the first method is still vulnerable to a hacking attack.

The second method is a method of dividing and storing values in a memory into a plurality of positions. For example, there are technologies of randomly selecting a memory address in which a program variable will be stored whenever the program variable is used and storing the program variable in the selected address. However, it may still be possible for a hacker to search for variables through an attack scheme of fixing pointers for the variables stored in the plurality of positions in the second method.

As such, in the related art, various ways for blocking a search are used to correspond to memory hacking. However, as described above, while these methods may make it difficult to search for variables, it is still possible to search for variables.

### SUMMARY

Example embodiments of the inventive concepts provide a memory hacking detecting method for more accurately detecting a level of a hacker (or a cheating user) and action of memory hacking by detecting the memory hacking on a stage-by-stage basis and/or a system therefor.

Example embodiments of the inventive concepts provide a method and/or system for assigning attributes to each of variable of a program executed on a memory and detecting memory hacking in different ways based on the assigned attributes.

Example embodiments of the inventive concepts provide a method and/or system for determining whether a hacker attempts to falsify any variable by assigning a name (e.g., an identifier parameter) to each of variable of a program executed on a memory and providing a name of a variable corresponding detected memory hacking as well as information about whether the memory hacking is detected.

Example embodiments of the inventive concepts provide a method and/or system for detecting memory hacking without the occurrence of additional costs in a process of developing or debugging a program by executing a protection function of assigning attributes to variables, redefining a type and an operator, or assigning names to the variables through a guide library when variables of the program operates the same as general variables and when the program is distributed and is executed on a real memory.

Some example embodiments relate to a memory hacking detecting method to detect memory hacking of a value of a variable associated with a program executed on a memory.

In some example embodiments, the method includes assigning attributes to the variable included in the program using a guard library, the guard library including variable attributes information; redefining, via the guide library, a type of a first variable to which first attributes are assigned and an operator to generate a redefined type and a redefined operator, respectively; first detecting the memory hacking of the first variable based on whether a value of the first variable is inconsistent with the redefined operator or the first variable deviates from a range of the redefined type; periodically monitoring a change of a value of a second variable to which second attributes are assigned; and second detecting the memory hacking of the second variable based on whether the change of the value of the second variable deviates from a change limitation set by the second attributes.

In some example embodiments, the second attributes indicate that the second variable is fixed, and the second detecting includes storing the value of the second variable in a data file, the data file containing stored values of read-only attributes; and detecting the memory hacking of the second variable, if the value of the second variable is different from a respective one of the stored values.

In some example embodiments, the second attributes indicate that the value of the second variable is expected to sequentially vary, and the second detecting includes detecting the memory hacking of the second variable, if the periodic monitoring does not detect that the value of the second variable sequentially varies compared to a previous value thereof.

In some example embodiments, assigning an identifier parameter to the variable included in the program using the guard library; and generating a message including information indicating that the memory hacking is detected and an identifier parameter of the variable corresponding to the memory hacking, if the memory hacking of the first variable or the memory hacking of the second variable is detected.

In some example embodiments, the method further includes generating a message including information indicating that the memory hacking is detected and information about attributes of the variable corresponding to the memory hacking, if the first detecting or the second detecting detects the memory hacking of the first variable or the second variable, respectively.

In some example embodiments, the method further includes storing a value of the variable in a storage position sequentially selected among a plurality of storage positions, if the value of the variable of the program changes; and managing indication information about each of the plurality of storage positions in which the changed value of the variable is stored.

In some example embodiments, the method further includes third detecting the memory hacking by monitoring whether the indication information is fabricated.

In some example embodiments, the method further includes changing a fishing value stored in a fishing storage position, if the value of the variable is changed; and detecting the memory hacking, if the value stored in the fishing storage position is falsified.

In some example embodiments, the method further includes duplicating and storing a value of a variable in a plurality of storage positions, if the value of the variable of the program is changed; and detecting the memory hacking by comparing the values duplicated and stored in the plurality of storage positions.

In some example embodiments, the method further includes distributing a file to install the program such that the file is distributed with the guard library.

Some example embodiments relate to a non-transitory computer-readable recording medium storing a program to detect memory hacking of a value of a variable associated with a program executed on a memory.

Some example embodiments relate to a memory hacking detecting device to detect memory hacking of a value of a variable of a program executed on a memory.

In some example embodiments, the device includes at least one processor configured to, assign attributes to the variable included in the program using a guard library, the guard library including variable attributes information, redefine, via the guide library, a type of a first variable to which first attributes are assigned and an operator to generate a redefined type and a redefined operator, respectively, detect the memory hacking of the first variable based on whether a value of the first variable is inconsistent with the redefined operator or whether the first variable deviates from a range of the redefined type, periodically monitor a change of a value of a second variable to which second attributes are assigned, and detect the memory hacking of the second variable based on whether the change of the value of the second variable deviates from a change limitation set by the second attributes.

In some example embodiments, the second attributes indicate that the second variable is fixed, and the at least one processor is further configured to, store the value of the second variable in a data file, the data file containing stored values of read-only attributes, and detect the memory hacking of the second variable, if the value of the second variable is different from a respective one of the stored values.

In some example embodiments, the second attributes indicate that the value of the second variable is expected to sequentially vary, and the at least one processor is configured to detect the memory hacking of the second variable, if the value of the second variable does not sequentially vary compared to a previous value thereof.

In some example embodiments, the at least one processor is further configured to, assign an identifier parameter to the variable included in the program using the guard library; and generate a message including information indicating that the memory hacking is detected and an identifier parameter of the variable corresponding to the memory hacking, if the at least one processor detects the memory hacking.

In some example embodiments, the at least one processor is further configured to generate a message including information indicating that the memory hacking is detected and information about attributes of the variable corresponding to the memory hacking, if the at least one processor detects the memory hacking.

In some example embodiments, the at least one processor is further configured to, store a value of the variable in a storage position sequentially selected among a plurality of storage positions, if the value of the variable is changed, and manage indication information about each of the plurality of storage positions in which the changed value of the variable is stored.

In some example embodiments, the at least one processor is further configured to detect the memory hacking by monitoring whether the indication information is fabricated.

In some example embodiments the at least one processor is further configured to, change a fishing value stored in a fishing storage position, if the value of the variable is changed, and detect the memory hacking, if the value stored in the fishing storage position is falsified.

In some example embodiments, the at least one processor is further configured to, duplicate and store a value of a variable in a plurality of storage positions, if the value of the variable of the program is changed, and detect the memory hacking by comparing the values duplicated and stored in the plurality of storage positions.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a drawing illustrating a network environment according to an example embodiment of the inventive concepts;

FIG. 2 is a block diagram illustrating a configuration of an electronic device and a configuration of a server in an example embodiment of the inventive concepts;

FIG. 3 is a block diagram illustrating a detailed configuration of a processor of an electronic device according to an example embodiment of the inventive concepts;

FIG. 4 is a flowchart illustrating a memory hacking detecting method performed by an electronic device according to an example embodiment of the inventive concepts;

FIG. 5 is a drawing illustrating a process of monitoring a variable to which second attributes are added, in an example embodiment of the inventive concepts;

FIG. 6 is a block diagram illustrating a detailed configuration of a processor of an electronic device according to another example embodiment of the inventive concepts;

FIG. 7 is a flowchart illustrating a memory hacking detecting method performed by an electronic device according to another example embodiment of the inventive concepts; and

FIG. 8 is a drawing illustrating a process of storing a value of a variable in a plurality of storage positions, in an example embodiment of the inventive concepts.

### DETAILED DESCRIPTION

Example embodiments will be described in detail with reference to the accompanying drawings. Example embodiments of the inventive concepts, however, may be embodied in various different forms, and should not be construed as being limited only to the illustrated example embodiments. Rather, these example embodiments are provided as examples so that this disclosure will be thorough and complete, and will fully convey the example embodiments of the inventive concepts to those skilled in the art. Accordingly, known processes, elements, and techniques are not described with respect to some of the example embodiments of the inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the example embodiments of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular example embodiments only and is not intended to be limiting of the example embodiments of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which these example embodiments of the inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be a computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, a description will be given in detail for example embodiments of the inventive concepts with reference to the accompanying drawings. However, the inventive concepts are not limited by example embodiments. Also, with respect to the descriptions of the drawings, like reference numerals refer to like elements.

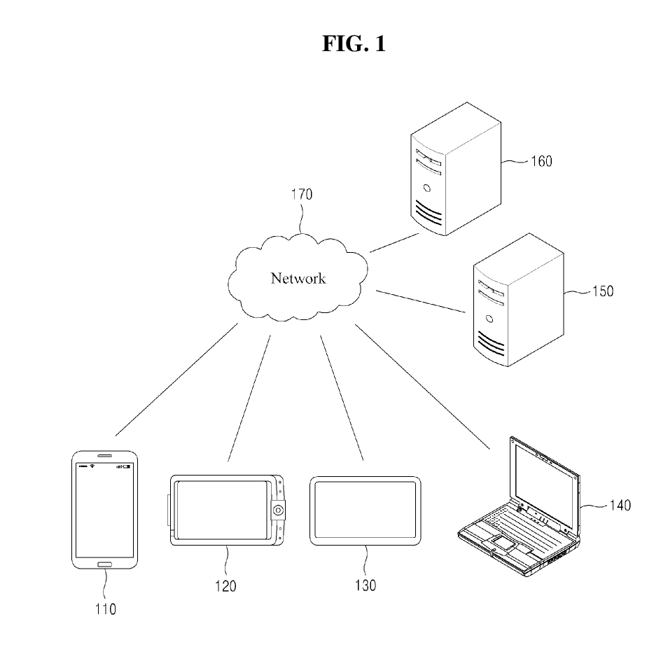

FIG. 1 is a drawing illustrating a network environment according to an example embodiment of the inventive concepts.

Referring to FIG. 1, in an example embodiment the network environment of FIG. 1 may include a plurality of electronic devices 110 to 140, a plurality of servers 150 and 160, and a network 170. However, the number of electronic devices and the number of servers may not be limited thereto.

Each of the electronic devices 110 to 140 may be a fixed terminal or a mobile terminal implemented with a computer device.

For example, the plurality of electronic devices 110 to 140 may be a smart phone, a mobile phone, a navigation device, a computer, a notebook, a digital broadcasting terminal, a personal digital assistant (PDA), a portable multimedia player (PMP), a tablet personal computer (PC), and the like. For example, the electronic device 110 may communicate with the other electronic devices 120 to 140 and/or the servers 150 and 160 through the network 170 using a wired or wireless communication scheme.

The scope and sprit of the example embodiments of the inventive concepts may not be limited to the aforementioned communication scheme. For example, there may be a communication scheme using a local area wireless communication network between devices as well as a communication scheme using a communication network (e.g., a mobile communication network, a wired internet, a wireless internet, and a broadcasting network) which may be included in the network 170. For example, the network 170 may include one or more of networks, such as a personal area network (PAN), a local area network (LAN), a campus area network (CAN), a metropolitan area network (MAN), a wide area network (WAN), a broadband network (BBN), and the Internet. Also, the network 170 may include, but is limited to, one or more of network topologies which include a bus network, a star network, a ring network, a mesh network, a star-bus network, a tree or hierarchical network, and the like.

Each of the servers 150 and 160 may be implemented with a computer device or a plurality of computer devices which may communicate with the plurality of electronic devices 110 to 140 through the network 170 to provide an instruction, a code, a file, content, a service, and the like to the plurality of electronic devices 110 to 140.

For example, the server 160 may provide a file for installing an application to the electronic device 110 connected through the network 170. In this case, the electronic device 110 may install the application using the file provided from the server 160. Also, the electronic device 110 may connect to the server 150 under control of an operating system (OS) and at least one program (e.g., a browser or the installed application) included in the electronic device 110 and may receive a service or content provided from the server 150. For one example, if the electronic device 110 sends a service request message to the server 150 through the network 170 under control of the application, the server 150 may send a code corresponding to the service request message to the electronic device 110. The electronic device 110 may configure and display a screen corresponding to the code under control of the application to provide content to its user. For another example, the server 150 may establish a communication session for a messaging service and may route a message between the plurality of electronic devices 110 to 140 through the established communication session.

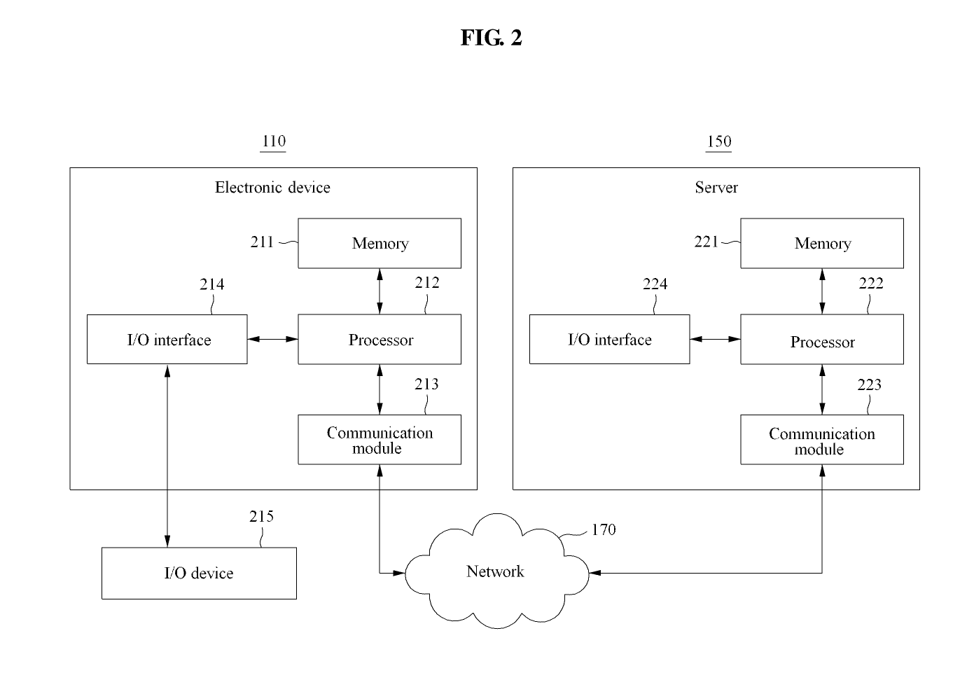

FIG. 2 is a block diagram illustrating a configuration of an electronic device and a configuration of a server in an example embodiment of the inventive concepts.

Referring to FIG. 2, for simplification purposes FIG. 2 illustrates the electronic device 110 of FIG. 1 and the server 150 of FIG. 1. However, components of the electronic device 110 may be the same or similar to those of each of the other electronic devices 120 to 140 of FIG. 1, and components of the server 150 may be the same or similar to those of the other server 160 of FIG. 1.

The electronic device 110 may include a memory 211, a processor 212, a communication module 213, and an input and output interface 214. The server 150 may include a memory 221, a processor 222, a communication module 223, and an input and output interface 224.

The memories 211 and 221 may be a non-volatile memory, a volatile memory, a hard disk, an optical disk, and a combination of two or more of the above-mentioned devices. The memory may be a non-transitory computer readable medium. The non-transitory computer-readable media may also be a distributed network, so that the program instructions are stored and executed in a distributed fashion. The non-volatile memory may be a Read Only Memory (ROM), a Programmable Read Only Memory (PROM), an Erasable Programmable Read Only Memory (EPROM), or a flash memory. The volatile memory may be a Random Access Memory (RAM).

Each of the memories 211 and 221 may be a computer-readable recording medium and may include a permanent mass storage device such as a random access memory (RAM), a read only memory (ROM), and a disc drive. Also, the memory 211 may store an OS and at least one program code (e.g., a code for a browser or application installed and driven in the electronic device 110). The memory 221 may store an OS and at least one program code. These software components may be loaded from a computer-readable recording medium, which is independent of the memories 211 and 221, using a drive mechanism. This computer-readable recording medium may include computer-readable recording media such as a floppy drive, a disc, a tape, a digital versatile disc/compact disc-ROM (DVD/CD-ROM) drive, and a memory card. In another example embodiment, the software components may be loaded into the memories 211 and 221 through the communication modules 213 and 223, respectively, rather than a computer-readable recording medium. For example, at least one program may be loaded into each of the memories 211 and 221 based on a program (e.g., the above-mentioned application) installed by files provided through the network 170 by developers or a file distribution system (e.g., the above-mentioned server 160) which distributes a file for installing an application.

The processors 212 and 222 may each be implemented by at least one semiconductor chip disposed on a printed circuit board. The processors 212 222 may each be an arithmetic logic unit, a digital signal processor, a microcomputer, a field programmable array, a programmable logic unit, a microprocessor or any other device capable of responding to and executing instructions in a defined manner.

Each of the processors 212 and 222 may be configured to process an instruction of a computer program by performing basic arithmetic, logic, and input and output operations. The instruction may be provided to the processor 212 by the memory 211 or the communication module 213. The instruction may be provided to the processor 222 by the memory 221 or the communication module 223. For example, each of the processor 212 and 222 may be configured to execute an instruction received based on a program code stored in a storage device such as the memories 211 and 221.

The processor 212 may be may be programmed with instructions that configure the respective processor 212, 222 into a special purpose computer to process data such that one or more of the processors 212, 222 may detect hacking of the memory 211 without the occurrence of additional costs in a process of developing or debugging a program. Therefore, the one or more of the processors 212, 222 may improve the functioning of the electronic devices 110 to 114 themselves.

Each of the communication modules 213, 222 may include transmitters and/or receivers. The transmitters may include hardware and any necessary software for transmitting signals including, for example, data signals and/or control signals. The receivers may include hardware and any necessary software for receiving signals including, for example, data signals and/or control signals.

Each of the communication modules 213 and 223 may provide a function such that the electronic device 110 and the server 150 communicate with each other through the network 170 and may provide a function such that another electronic device (e.g., the electronic device 120) and another server (e.g., the server 160) communicates with each other through the network 170. For example, a request (e.g., a streaming service request for content) generated by the processor 212 of the electronic device 110 based on a program code stored in a recording device such as the memory 211 may be transmitted to the server 150 through the network 170 under control of the communication module 213. In contrast, a control signal or instruction, content, a file, and the like provided under control of the processor 222 of the server 150 may be received in the electronic device 110 through the communication 213 of the electronic device 110, through the communication module 223 and the network 170. For example, the control signal or instruction of the server 150, received through the communication module 213, may be sent to the processor 212 or the memory 211. The content or file of the server 150 may be stored in a storing medium which may be further included in the electronic device 110.

The input and output interface 214 may be a means for interfacing with the input and output device 215. For one example, the input device may include a device such as a keyboard, or a mouse. The output device may include a device such as a display for displaying a communication session of an application. For another example, the input and output interface 214 may be a means for interfacing with a device, such as a touch screen, in which an input function and an output function are integrated into one. Specifically, in processing an instruction of a computer program loaded into the memory 211, the processor 212 of the electronic device 110 may display a service screen or content, configured using data provided from the server 150 or the electronic device 120, on a display of the electronic device 110 through the input and output interface 214.

Also, in other example embodiments, the electronic device 110 may include more components other than those shown in FIG. 2. The server 150 may include more components than those shown in FIG. 2. However, it is unnecessary to describe or illustrate most conventional components in elaborate detail. For example, the electronic device 110 may be implemented to include at least some of components of the above-mentioned input and output device 215 or may further include other components such as a transceiver, a global positioning system (GPS) module, a camera, various sensors, and a database.

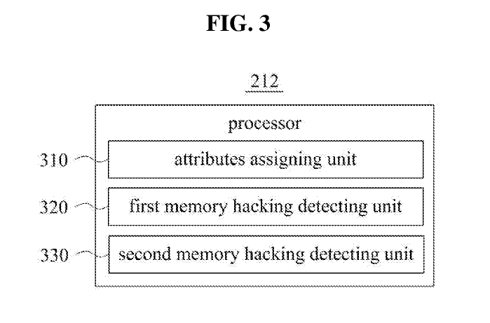

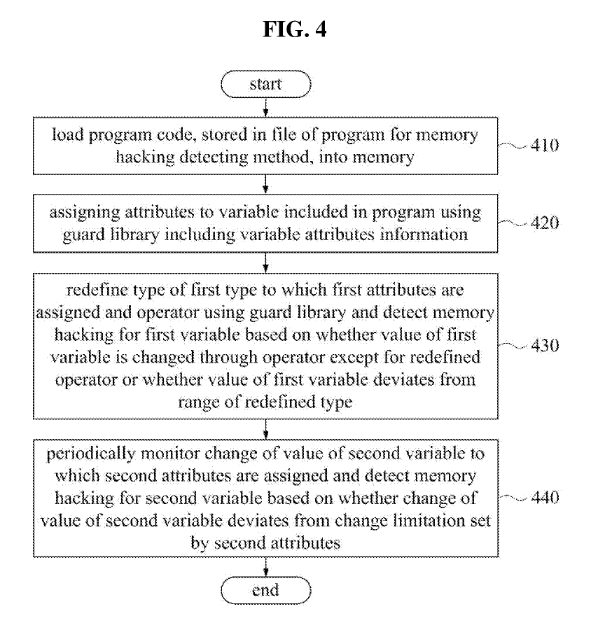

FIG. 3 is a block diagram illustrating a detailed configuration of a processor of an electronic device according to an example embodiment of the inventive concepts. FIG. 4 is a flowchart illustrating a memory hacking detecting method performed by an electronic device according to an example embodiment of the inventive concepts.

Referring to FIGS. 2-4, the electronic device 110 of FIG. 2 may be implemented as a memory hacking detecting system.

For example, as shown in FIG. 3, the processor 212 of the electronic device 110 may execute code that configures the processor 212 to perform the functions of an attributes assigning unit 310, a first memory hacking detecting unit 320, and a second memory hacking detecting unit 330.

The processor 212 and the components of the processor 212 may control the electronic device 110 to perform operations 410 to 440 included in a memory hacking detecting method of FIG. 4 and may be implemented to execute a code of an operating system (OS) and a code (e.g., a computer-readable instruction) of at least one program (e.g., an application), included in a memory 211 of FIG. 2, to perform this control.

In operation 410, the processor 212 may load a program code, stored in a file of a program for the memory hacking detecting method, into the memory 211. For example, the file of the program may be provided from a file distribution system to the electronic device 110 through the network 170 of FIG. 2 and may be used to install the program in the electronic device 110. If the program installed in the electronic device 110 is executed, the processor 212 may load the program code into the memory 211.

In this case, the processor 212 and each of the attributes assigning unit 310, the first memory hacking detecting unit 320, and the second memory hacking detecting unit 330 included in the processor 212 may execute a corresponding portion of the program codes loaded into the memory 211 to execute subsequent operations 420 and 440. In this case, the processor 212 and the components of the processor 212 may control the electronic device 110 in executing the memory hacking detecting method. For example, the processor 212 may control the electronic device 110 to store specific data (e.g., a value of a variable) in the memory 211 included in the electronic device 110.

In operation 420, the processor 212, for example, the attributes assigning unit 310 included in the processor 212 may assign attributes to a variable included in the program using a guide library including variable attributes information.

For one example, in case of a variable, a value of which is changed through only an operator, first attributes as operator attributes may be assigned to the corresponding variable. As described below, memory hacking may be detected for this variable by redefining a type of the variable and the operator.

For another example, there may be variables which are difficult to be protected from memory hacking or detect the memory hacking through the redefinition of the operator. Second attributes may be assigned to these variables. For a specific example, there may be a variable having a static value, a value of which is not changed, or a variable, a value of which is only increased or decreased. In this case, unchangeable attributes may be assigned as the second attributes to the variable having the static value. Increase attributes may be assigned as the second attributes to the variable, the value of which is only increased. Decrease attributes may be assigned as the second attributes to the variable, the value of which is only decreased.

The guide library may be added to a file in a process of distributing the file for installing a program. For example, developers may develop a program without separate consideration for memory hacking and may distribute a file for installing a program. In this case, the guide library may be added to a file (e.g., an Android application package (APK) file) in a process of distributing the file. This guide library may be added to a file of a program through a system of a developer, a file distribution system, such as an app store, which manages to download a program, or a separate protective system.

In operation 430, the processor 212, for example, the first memory hacking detecting unit 320 may redefine a type of a first variable to which the first attributes are assigned and an operator using the guide library. The processor 212, for example, the first memory hacking detecting unit 320 may detect memory hacking for the first variable based on whether the value of the first variable is changed through an operator except for the redefined operator or whether the value of the first variable deviates from a range of the redefined type.

Basically, a type of a variable and an operator may be defined through an operating system (OS) on which a program is executed or a program language. For example, a variable of the “INT” type may be defined to have an integer value, and a variable of the “FLOAT” type may be defined to have a real number value. Also, the operator “+” may be defined to generate a value in which left and right variable values are added, and the operator “−” may be defined to generate a difference value between left and right variable values.

In this case, the processor 212, for example, the first memory hacking detecting unit 320 may redefine a type of a variable and an operator with respect to the variable (e.g., a first variable), to which the first attributes are assigned, among variables. For example, the first memory hacking detecting unit 320 may redefine a type such that the variable of the “INT” type has a plus integer value and such that the variable of the “FLOAT” type has a plus real number value. Also, the first memory hacking detecting unit 320 may redefine an operator such that the operator “+” generates an absolute value of a value in which left and right variable values are added and such that the operator “−” generates an absolute value of a difference value between the left and right variable values.

In this case, if a value of the first variable is not changed by the redefined operator, the first memory hacking detecting unit 320 may detect memory hacking for the first variable. Alternatively, the first memory hacking detecting unit 320 may detect memory hacking for the first variable based on whether the value of the first variable deviates from a range of the redefined type. For example, if the first variable of the redefined “INT” type has a minus value, the first memory hacking detecting unit 320 may detect memory hacking.

In operation 440, the processor 212, for example, the second memory hacking detecting unit 330 may periodically monitor a change of a value of a second variable to which the second attributes are assigned and may detect memory hacking for the second variable based on whether the change of the value of the second variable deviates from change limitation set by the second attributes.

If the above-mentioned first attributes are attributes for a range a value a variable may have based on a type of the variable, the second attributes may be attributes of the variable itself. As described above, the second attributes may include unchangeable attributes of a variable, a value of which should be fixed, increase attributes of a variable, a value of which should always be increased, or decrease attributes of a variable, a value of which should always be decreased.

For one example, in operation 440, the second memory hacking detecting unit 330 may manage a value of the second variable, to which the unchangeable attributes are assigned, using a data file of read-only attributes. If the value of the second variable is different from a value stored the data file of the read-only attributes, the second memory hacking detecting unit 330 may detect memory hacking for the second variable. Since it may be difficult (or, alternatively, impossible) to change data stored in the data file of the read-only attributes, the second memory hacking detecting unit 330 may store the value of the second variable, to which the unchangeable attributes are assigned, in the corresponding data file and may determine whether the second value is changed by comparing the stored value of the second variable with a value of the second variable. In this case, since that the value of the second variable to which the unchangeable attributes are assigned is changed means may indicate that memory hacking occurs, the second memory hacking detecting unit 330 may detect the memory hacking.

For another example, if the value of the second variable, periodically monitored in operation 440, to which the increase attributes are assigned, is not increased compared to a previous value, or if the value of the second variable, periodically monitored in operation 440, to which the decrease attributes are assigned, is not decreased compared to a previous value, the second memory hacking detecting unit 330 may detect memory hacking for the second variable. For example, the increase attributes or the decrease attributes may be assigned to the second variable associated with time on a game. This second variable should be continuously increased or decreased over time. However, if the second variable is not increased or decreased, the second memory hacking detecting unit 330 may detect memory hacking.

An order of executing operation 430 and an order of executing operation 440 may be changed and may simultaneously performed.

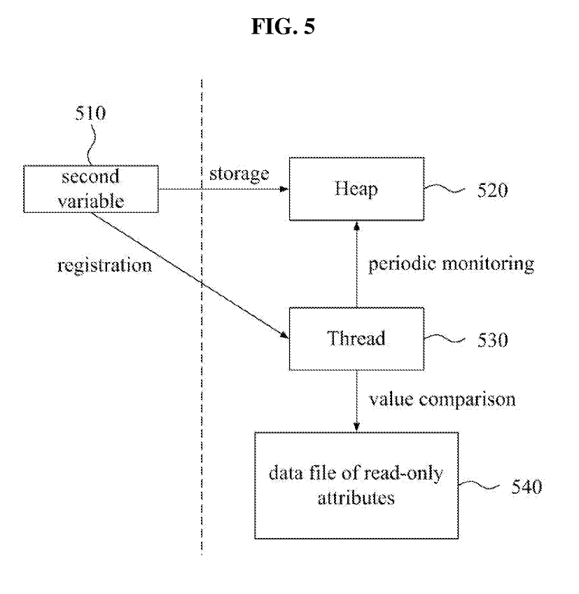

FIG. 5 is a drawing illustrating a process of monitoring a variable to which second attributes are added according to an example embodiment of the inventive concepts.

Referring to FIG. 5, a value of a second variable 510 to which the second attributes are assigned may be stored in a storage area of a memory, such as a heap 520 or a stack, which is allocated to the second variable 510.

A hacker may perform memory hacking by searching the storage area of the memory, which stores the second variable 510. If the second variable 510 is registered after the second attributes are assigned to the second variable 510, the second memory hacking detecting unit 330 described with reference to FIGS. 3 and 4 may detect the memory hacking by generating a thread 530 for monitoring whether a value is falsified and periodically monitoring value of the second variable 510, which is stored in the storage area (e.g., the heap 510 of FIG. 5).

For example, assuming that the second variable 510 of FIG. 5 is a variable to which unchangeable attributes are assigned, the value of the second variable 510 may be stored in a data file 540 of the read-only attributes, when the second variable 510 is registered. In this case, the second memory hacking detecting unit 330 may detect memory hacking for the second variable 510 by comparing the value stored in the heap 520 with the value stored in the data file 540 of the read-only attributes using the thread 530.

In this case, the second variable 510 may be set in a step of developing a program (e.g., using a software development kit (SDK)), and storing a value of the second variable 510, assigning attributes to the second variable 510, monitoring the second variable 510, and the like may be performed using a guide library. Therefore, developers may focus on developing a program without the necessity of considering memory hacking.

Also, a memory hacking detecting system may provide information about a variable for detected memory hacking. For this purpose, an identifier parameter such as a specific name may be assigned to a variable. For example, since a global variable and a local variable have the same name (e.g., a global variable “a” and a local variable “a” are different variables), it is difficult to identify a specific variable using a name of a variable in a program code. Therefore, an identifier parameter for the specific variable may be additionally added to the added specific variable. The memory hacking detecting system may determine whether a hacker attempts to falsify a value of any variable by providing this identifier parameter to the variable associated with memory hacking.

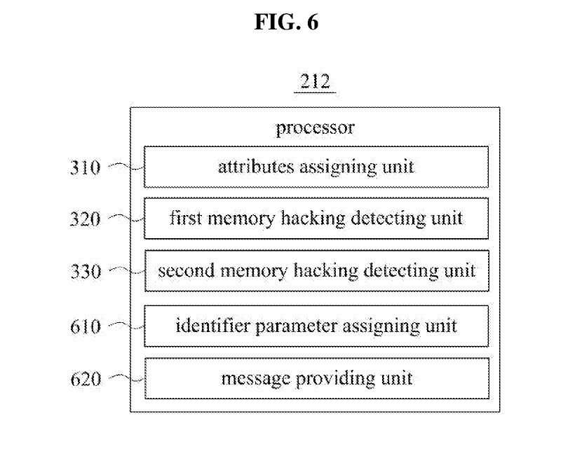

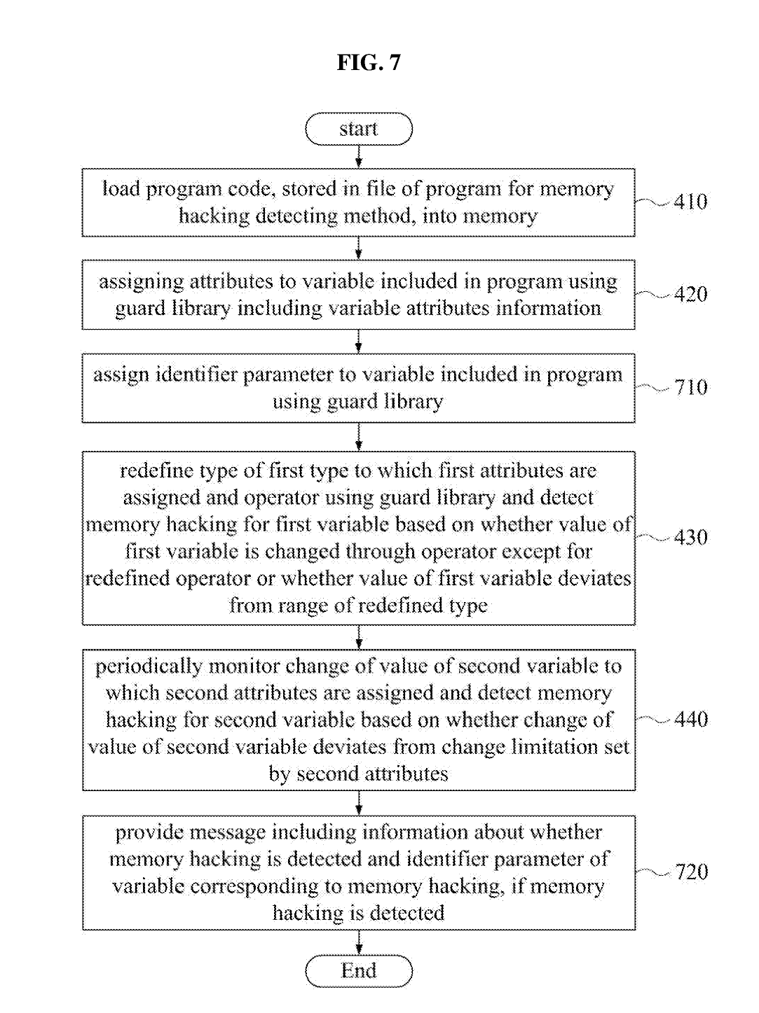

FIG. 6 is a block diagram illustrating a detailed configuration of a processor of an electronic device according to another example embodiment of the inventive concepts. FIG. 7 is a flowchart illustrating a memory hacking detecting method performed by an electronic device according to another example embodiment of the inventive concepts.

Referring to FIGS. 6 and 7, as shown in FIG. 6, a processor 212 of the electronic device 110 of FIG. 2 may execute code that further configures the processor 212 to perform the operations of an identifier parameter assigning unit 610 and a memory providing unit 620, in addition to the operations of the attributes assigning unit 310, the first memory hacking detecting unit 320, and the second memory hacking detecting unit 330 shown in FIG. 3.

The processor 212 and the components of the processor 212 may control the electronic device 110 to perform operations 410 to 440, 710, and 720 included in a memory hacking detecting method of FIG. 7 and may be implemented to execute a code of an OS and a code (e.g., a computer-readable instruction) of at least one program (e.g., an application), included in the memory 211 of FIG. 2, to perform this control.

Since the description is previously given of the attributes assigning unit 310, the first memory hacking detecting unit 320, and the second memory hacking detecting unit 330, and steps 410 to 440 with reference to FIGS. 3 and 4, the repeated description will be omitted below.

The processor 212 may perform operation 710 after operation 410 or operation step 430. In FIG. 7, an example embodiment is illustrated in which operation 710 is performed after operation 420. However, the scope and spirit of the inventive concepts may not be limited thereto. For example, operation 710 may be performed after operation 410.

In operation 710, the processor 212, for example, the identifier parameter assigning unit 610 may assign an identifier parameter to a variable included in a program using a guard library. Each of the variables may be identified through this identifier parameter.

For one example, the conventional variable “INT m_HP” may be redefined by assigning the identifier parameter “physical fitness” and the operator attributes “ARMOR_OPERATOR” to the conventional variable “INT m_HP”, thus being represented as “m_HP.Init (“physical fitness”, ARMOR_OPERATOR)”.

For another example, the identifier parameter “resource value”, the unchangeable attributes “ARMOR_UNCHANGEABLE”, and the static value “256” may be assigned to the conventional variable “BYTE m_StaticValue”. Therefore, the conventional variable “BYTE m_StaticValue” may be represented as “m_StaticValue.Byte” (“resource value”, ARMOR_UNCHANGEABLE, 256).

Operations 430 and 440 may be performed after operations 420 and 710 are performed. In this case, the processor 212 may perform operation 720 after memory hacking is detected through operation 430 or 440.

In operation 720, if the memory hacking is detected, the processor 212, for example, the message providing unit 620 may provide a message including information about whether the memory hacking is detected and an identifier parameter of a variable corresponding to the memory hacking. The provided message may be sent to a system of a developer, a server 150 of FIG. 2 which provides a service through a program, and/or a server 160 of FIG. 1 which provides a file for installing a program through the electronic device 110. Therefore, the developer, a service provider, and/or a program distributor may accurately detect action of memory hacking and may perform post processing (e.g., restrictions on a corresponding user) through a business analysis based on the detected information.

In another example embodiment, the processor 212, for example, the message providing unit 620 may provide information about attributes which are assigned to a variable. For example, if memory hacking is detected, the message providing unit 620 may provide a message including information about whether the memory hacking is detected and information about attributes of a variable corresponding to the memory hacking. In this case, the developer, the service provider, and/or the program distributor may determine whether a hacker attempts to falsify a variable of any attributes. In this case, the identifier parameter assigning unit 610 or operation 710 may be omitted. Also, in another example embodiment, the message providing unit 620 may send a message including all of an identifier parameter and attributes for a variable which attempts to perform memory hacking.

The processor 212 may store a changed value of a variable in a plurality of storage positions rather than one storage position. Also, the processor 212 may guide hackers to attempt to falsify a fishing value rather than a true value of a variable using the fishing value of the variable. Also, the processor 212 may monitor whether a value of the variable is falsified by backing the true value of the variable up by duplicating and storing the true value of the variable.

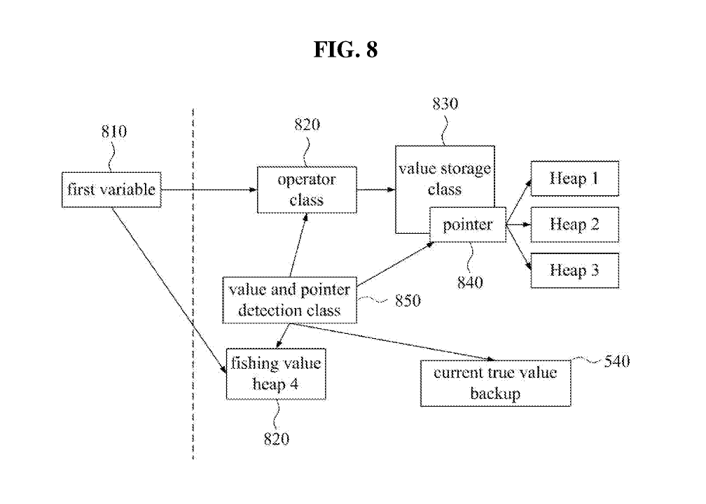

FIG. 8 is a drawing illustrating a process of storing a value of a variable in a plurality of storage positions, in an example embodiment of the inventive concepts.

Referring to FIG. 8, as discussed below, the processor 212 may store a value of a variable in a plurality of storage positions.

In some example embodiments, the processor 212 of FIG. 2 may further execute instructions that configure the processor 212 to perform the operations of a variable value management unit (not shown).

The variable value management unit may perform an operation (not shown) of allocating the plurality of storage positions, for storing a value of a variable, to the one variable of a program, storing a changed value of the variable in a storage position sequentially selected among the plurality of storage positions if the value of the one variable is changed, and managing indication information about each of the plurality of storage positions in which the changed value of the variable is stored. This operation (not shown) may be performed after operation 410 of FIG. 7 or before operation 430 of FIG. 7. For example, in an example embodiment of FIG. 8, a changed value for a first variable 810 may be sequentially stored in a plurality of storage positions (e.g., a heap 1, a heap 2, and a heap 3) through an operator class 820 and a value storage class 830 of a secure library for processing a redefined operator. After a first changed value of the first variable 810 is stored in the heap 1, a second changed value of the first variable 810 may be stored in the heap 2. In other words, since a value of one variable is stored in a plurality of storage positions, it may be difficult for a hacker to obtain the value for the specific value. Although the hacker obtains the value for the specific variable, if he or she falsifies the value, since the processor 212 should store the falsified value in a new storage position, it may block memory hacking for the corresponding variable.

In this case, the processor 212 may further include a third memory hacking detecting unit (not shown). The third memory hacking detecting unit may perform an operation (not shown) of detecting memory hacking by monitoring whether indication information is fabricated. For example, FIG. 8 illustrates a pointer 840 as an example of the indication information. In this case, the third memory hacking detecting unit may detect memory hacking by detecting falsification or fixing of the pointer 840 through a value and pointer detection class 850 of the secure library. This operation (not shown) may be performed after operation 420 or 710 of FIG. 7.

A description will be given of an example embodiment of using a fishing value of a variable.

The processor 212 may further include a fishing value management unit (not shown). The fishing value management unit may perform an operation (not shown) of allocating a fishing storage position, for storing a fishing value, to a value of a variable of a program and changing the fishing value stored in the fishing storage position to a value if the value of the variable is changed. This operation (not shown) may be performed before operation 430 of FIG. 4. For example, in FIG. 8, in an example embodiment, a fishing value for the first variable 810 is stored in a fishing value heap 4 820 as the fishing storage position.

In this case, the processor 212 may further execute code that configures the processor 212 to perform the operations of a fourth memory hacking detecting unit (not shown). The fourth memory hacking detecting unit may perform an operation (not shown) of detecting the memory hacking based on whether the value stored in the fishing storage position is falsified. This operation (not shown) may be performed after operation 420 or 710 of FIG. 7. For example, in FIG. 8, the fourth memory hacking detecting unit may detect the memory hacking by detecting falsification of a fishing value through the value and pointer detection class 850 of the secure library. The fishing value may be preset. If a value stored in the fishing value heap 4 820 is falsified into a value which is different from the value, the fourth memory hacking detecting unit may determine that a hacker attempts to perform memory hacking.

Also, a description will be given of an example embodiment of duplicating and storing a true value of a variable.

The processor 212 may further execute code that configures the processor 212 to perform the operations of a variable value management unit (not shown) and a fifth memory hacking detecting unit (not shown).

The variable value management unit may perform an operation (not shown) of duplicating and storing a value of a variable in a plurality of storage positions if the value of the variable of a program is changed. This operation (not shown) may be performed before operation 430 of FIG. 4 after operation 410.

Also, the fifth memory hacking detecting unit may perform an operation (not shown) of detecting falsification of the changed value of the variable by comparing values duplicated and stored in the plurality of positions. This operation (not shown) may be performed after operation 420 or 710 of FIG. 7. For example, in FIG. 8, a true value of the first variable 810 may be stored in a current true value backup 540 which is a duplication and storage space. In this case, the fifth memory hacking detecting unit may determine whether a value of the first variable 810 is falsified by comparing a current true value stored in one of the heap 1, the heap 2, and the heap 3 through the value and pointer detecting class 850 of the secure library with a true value stored in the current true value backup 540.

As such, according to example embodiments of the inventive concepts, the memory hacking detecting system may accurately detect a level of a hacker (or a cheating user) and action of memory hacking by detecting the memory hacking on a stage-by-stage basis. Also, the memory hacking detecting system may assign attributes to each of variables of a program executed on a memory and may detect memory hacking in different ways based on the assigned attributes.

Also, the memory hacking detecting system may determine whether a hacker attempts to falsify any variable by assigning a name (e.g., an identifier parameter) to each of variables of a program executed on a memory and providing a name of a variable corresponding detected memory hacking as well as information about whether the memory hacking is detected.

In addition, the memory hacking detecting system may detect memory hacking without the occurrence of additional costs in a process of developing or debugging a program by executing a protection function of assigning attributes to variables, redefining a type and an operator, or assigning names to the variables through a guide library when variables of the program operates the same as general variables and when the program is distributed and is executed on a real memory.

The foregoing devices may be realized by hardware elements, software elements and/or combinations thereof. For example, the devices and components illustrated in the example embodiments of the inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described example embodiments of the inventive concepts may be implemented with program instructions which may be executed through various computer means and may be recorded in computer-readable media. The media may also include, alone or in combination with the program instructions, data files, data structures, and the like. The program instructions recorded in the media may be designed and configured specially for the example embodiments of the inventive concepts or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described example embodiments of the inventive concepts, or vice versa.

While a few example embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

According to an example embodiment, the memory hacking detecting system may more accurately detect a level of a hacker (or a cheating user) and action of memory hacking by detecting the memory hacking on a stage-by-stage basis.

According to an example embodiment, the memory hacking detecting system may assign attributes to each of variables of a program executed on a memory and may detect memory hacking in different ways based on the assigned attributes.

According to an example embodiment, the memory hacking detecting system may determine whether a hacker attempts to falsify any variable by assigning a name (e.g., an identifier parameter) to each of variables of a program executed on a memory and providing a name of a variable corresponding detected memory hacking as well as information about whether the memory hacking is detected.

According to an example embodiment, the memory hacking detecting system may detect memory hacking without the occurrence of additional costs in a process of developing or debugging a program by executing a protection function of assigning attributes to variables, redefining a type and an operator, or assigning names to the variables through a guide library when variables of the program operates the same as general variables and when the program is distributed and is executed on a real memory.

Therefore, other implements, other example embodiments, and equivalents to claims are within the scope of the following claims.

What is claimed is:

1. A memory hacking detecting method to detect memory hacking of a value of a variable associated with a program executed on a memory, the method comprising:
assigning attributes to the variable included in the program using a guard library, the guard library including variable attributes information;
redefining, via the guide library, a type of a first variable to which first attributes are assigned and an operator to generate a redefined type and a redefined operator, respectively;
first detecting the memory hacking of the first variable based on whether a value of the first variable is inconsistent with the redefined operator or the first variable deviates from a range of the redefined type;
periodically monitoring a change of a value of a second variable to which second attributes are assigned; and
second detecting the memory hacking of the second variable based on whether the change of the value of the second variable deviates from a change limitation set by the second attributes.

2. The method of claim 1, wherein the second attributes indicate that the second variable is fixed, and the second detecting comprises:
storing the value of the second variable in a data file, the data file containing stored values of read-only attributes; and
detecting the memory hacking of the second variable, if the value of the second variable is different from a respective one of the stored values.

3. The method of claim 1, wherein the second attributes indicate that the value of the second variable is expected to sequentially vary, and the second detecting comprises:
detecting the memory hacking of the second variable, if the periodic monitoring does not detect that the value of the second variable sequentially varies compared to a previous value thereof.

4. The method of claim 1, further comprising:
assigning an identifier parameter to the variable included in the program using the guard library; and
generating a message including information indicating that the memory hacking is detected and an identifier parameter of the variable corresponding to the memory hacking, if the memory hacking of the first variable or the memory hacking of the second variable is detected.

5. The method of claim 1, further comprising:
generating a message including information indicating that the memory hacking is detected and information about attributes of the variable corresponding to the memory hacking, if the first detecting or the second detecting detects the memory hacking of the first variable or the second variable, respectively.

6. The method of claim 1, further comprising:
storing a value of the variable in a storage position sequentially selected among a plurality of storage positions, if the value of the variable of the program changes; and
managing indication information about each of the plurality of storage positions in which the changed value of the variable is stored.

7. The method of claim 6, further comprising:
third detecting the memory hacking by monitoring whether the indication information is fabricated.

8. The method of claim 1, further comprising:
changing a fishing value stored in a fishing storage position, if the value of the variable is changed; and
detecting the memory hacking, if the value stored in the fishing storage position is falsified.

9. The method of claim 1, further comprising:
duplicating and storing a value of a variable in a plurality of storage positions, if the value of the variable of the program is changed; and
detecting the memory hacking by comparing the values duplicated and stored in the plurality of storage positions.

10. The method of claim 1, further comprising:
distributing a file to install the program such that the file is distributed with the guard library.

11. A non-transitory computer-readable recording medium storing a program to execute the method of claim 1.

12. A memory hacking detecting device to detect memory hacking of a value of a variable of a program executed on a memory, the device comprising:
at least one processor configured to,
assign attributes to the variable included in the program using a guard library, the guard library including variable attributes information,
redefine, via the guide library, a type of a first variable to which first attributes are assigned and an operator to generate a redefined type and a redefined operator, respectively,
detect the memory hacking of the first variable based on whether a value of the first variable is inconsistent with the redefined operator or whether the first variable deviates from a range of the redefined type,
periodically monitor a change of a value of a second variable to which second attributes are assigned, and
detect the memory hacking of the second variable based on whether the change of the value of the second variable deviates from a change limitation set by the second attributes.

13. The device of claim 12, wherein the second attributes indicate that the second variable is fixed, and the at least one processor is further configured to,
store the value of the second variable in a data file, the data file containing stored values of read-only attributes, and
detect the memory hacking of the second variable, if the value of the second variable is different from a respective one of the stored values.

14. The device of claim 12, wherein the second attributes indicate that the value of the second variable is expected to sequentially vary, and
the at least one processor is configured to detect the memory hacking of the second variable, if the value of the second variable does not sequentially vary compared to a previous value thereof.

15. The device of claim 12, wherein the at least one processor is further configured to,
assign an identifier parameter to the variable included in the program using the guard library; and
generate a message including information indicating that the memory hacking is detected and an identifier parameter of the variable corresponding to the memory hacking, if the at least one processor detects the memory hacking.

16. The device of claim 12, wherein the at least one processor is further configured to generate a message including information indicating that the memory hacking is detected and information about attributes of the variable corresponding to the memory hacking, if the at least one processor detects the memory hacking.

17. The device of claim 12, wherein the at least one processor is further configured to,
store a value of the variable in a storage position sequentially selected among a plurality of storage positions, if the value of the variable is changed, and
manage indication information about each of the plurality of storage positions in which the changed value of the variable is stored.

18. The device of claim 17, wherein the at least one processor is further configured to,
detect the memory hacking by monitoring whether the indication information is fabricated.

19. The device of claim 12, wherein the at least one processor is further configured to,
change a fishing value stored in a fishing storage position, if the value of the variable is changed, and
detect the memory hacking, if the value stored in the fishing storage position is falsified.

20. The device of claim 12, wherein the at least one processor is further configured to,
duplicate and store a value of a variable in a plurality of storage positions, if the value of the variable of the program is changed, and
detect the memory hacking by comparing the values duplicated and stored in the plurality of storage positions.
